(19) United States
(12) Patent Application Publication
(10) Pub. No.: US 2023/0003585 A1
(43) Pub. Date: Jan. 5, 2023

(54) INFORMATION PROCESSING APPARATUS, INFORMATION PROCESSING SYSTEM, INFORMATION PROCESSING METHOD, AND STORAGE MEDIUM

(71) Applicants: Akito TAJIMA, Kanagawa (JP); Shotaro KOMOTO, Kanagawa (JP); Keiji OHMURA, Kanagawa (JP)

(72) Inventors: Akito TAJIMA, Kanagawa (JP); Shotaro KOMOTO, Kanagawa (JP); Keiji OHMURA, Kanagawa (JP)

(21) Appl. No.: 17/771,814

(22) PCT Filed: Dec. 17, 2020
(86) PCT No.: PCT/IB2020/062077

§ 371 Date: Apr. 26, 2022

(30) Foreign Application Priority Data
Jan. 8, 2020 (JP) 2020-001631

(51) Int. Cl. G01J 5/48; G01J 5/02; G01J 5/08; G06T 7/11; H04L 51/224

(52) U.S. Cl. CPC G01J 5/48; G01J 5/025; G01J 5/0859; G06T 7/11; H04L 51/224; G06T 2207/10024; G06T 2207/10048

(57) ABSTRACT

An information processing apparatus includes: an information receiver configured to receive imaging data output from an imaging device; and a processing unit configured to generate a color image based on the received imaging data and control a display device to display the generated color image. The processing unit generates a detection frame constituted as plural regions based on the imaging data, controls the display device to display the generated detection frame as being superimposed on the color image, and displays a temperature for each of the plural regions.

### TECHNICAL FIELD

The present disclosure relates to an information processing apparatus, an information processing system, a method of processing information, and a storage medium.

### BACKGROUND ART

A technique is known in which thermal image data from a thermal image sensor is input and the thermal image data is converted into an RGB (Red/Green/Blue) image and visualized based on a preset color map (for example, Patent Literature (PTL) 1). PTL 1 further describes segmenting the thermal image data into a plurality of area data, setting a threshold temperature for each area, comparing a temperature of each area with the threshold temperature, and issuing a notification when the temperature of any area exceeds the threshold temperature. Examples of the thermal image sensor include a thermographic camera, which inputs an amount of infrared rays generated from a monitoring target such as equipment and outputs the amount of infrared rays as thermal image data. According to PTL 1, a trend graph is created based on setting information of a detection area that is set by an operator at will in a monitoring area (corresponding to an angle of view of the thermal image sensor), and the generated trend graph is displayed on a display device in real time.

### CITATION LIST

### Patent Literature

[PTL 1]
Japanese Unexamined Patent Application Publication No. 2010-216858

### SUMMARY OF INVENTION

### Technical Problem

However, according to the background art, the detection area is limited to a part of the monitoring area. Therefore, for example, in a case where sparks or the like produced from an object to be monitored that in an abnormal state leaps to a device or the like existing outside the detection area, a temperature of the device may become an abnormal value. However, since the device exists outside the detection area, the abnormality value of the temperature is hard to be detected. As described above, in the background art, there is room for improvement in detecting the temperature of an object to be monitored.

In view of the above issue, an object of the present disclosure is to appropriately detect a temperature of an object to be monitored.

### Solution to Problem

Example embodiments of the present disclosure include an information processing apparatus including: an information receiver configured to receive imaging data output from an imaging device; and a processing unit configured to generate a color image based on the received imaging data and control a display device to display the generated color image. The processing unit generates a detection frame constituted as plural regions based on the imaging data, controls the display device to display the generated detection frame as being superimposed on the color image, and displays a temperature for each of the plural regions.

### Advantageous Effects of Invention

According to one or more embodiments of the present disclosure, a temperature of an object to be monitored is appropriately detected.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an example of a configuration an information processing apparatus, according to an embodiment of the present disclosure.

FIG. 2 is a diagram illustrating an example of data to be transmitted to a display device, according to an embodiment of the present disclosure.

FIG. 3 is a view of a device, which includes a monitoring target, viewed from the side, according to an embodiment of the present disclosure.

FIG. 4 is a view of the device, which includes the monitoring target, viewed from the above, according to an embodiment of the present disclosure.

FIG. 5 is a diagram for describing an overview of a monitoring operation performed by the information processing apparatus, according to an embodiment of the present disclosure.

FIG. 6 is a diagram illustrating an example of a hardware configuration of the information processing apparatus, according to an embodiment of the present disclosure.

FIG. 7 is a diagram illustrating an example of a hardware configuration of a camera, according to an embodiment of the present disclosure.

FIG. 8 is a diagram illustrating an example of functional configurations of the information processing apparatus and the camera, according to an embodiment of the present disclosure.

FIG. 9 is a flowchart illustrating an example of operation performed by the information processing apparatus, according to an embodiment of the present disclosure.

FIG. 10A and FIG. 10B are diagrams illustrating examples of a detection frame and a color image, according to an embodiment of the present disclosure.

FIG. 11 is a diagram illustrating an example of the color image displayed on a graphical user interface (GUI) screen, according to an embodiment of the present disclosure.

FIG. 12 is a diagram illustrating a state in which the detection frame is superimposed on the color image on the GUI screen, according to an embodiment of the present disclosure.

FIG. 13 is a diagram for describing an operation performed in step S12 and the subsequent steps, according to an embodiment of the present disclosure.

FIGS. 14A and 14B are flowcharts illustrating an example of operation, according to a variation of the present disclosure.

FIG. 15 is a diagram illustrating an example of an RGB image displayed on the GUI screen, according to an embodiment of the present disclosure.

FIG. 16 is a diagram illustrating a state in which the detection frame is superimposed on the RGB image on the GUI screen, according to an embodiment of the present disclosure.

FIG. 17 is a diagram illustrating an example of display of a graph indicating a tendency of temperature change.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described with reference to accompanying drawings.

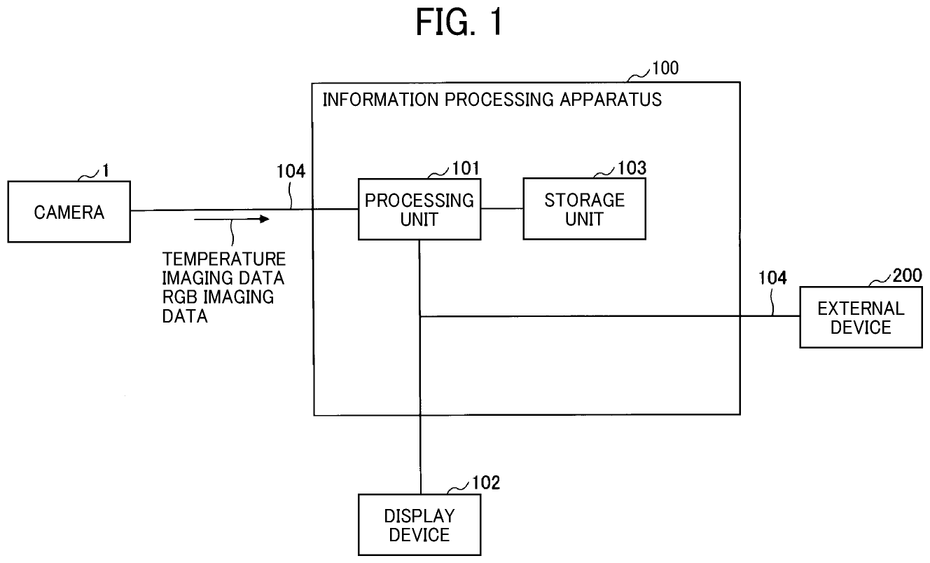

FIG. 1 is a diagram illustrating an example of a configuration an information processing apparatus 100, according to the present embodiment. The information processing apparatus 100 includes a processing unit 101 that acquires imaging data from a camera 1 and performs various processing, and a storage unit 103 that stores various types of data. The camera 1 is an example of an imaging device. Further, the information processing apparatus 100 is connected to a display device 102 that displays a result of processing by the processing unit 101. Although in the example of FIG. 1, the display device 102 is external to the information processing apparatus 100, in another example the information processing apparatus 100 includes the display device 102.

The imaging data includes at least temperature imaging data, and preferably further includes RGB imaging data. A detailed description is given below of the temperature imaging data and the RGB imaging data.

An external device 200 such as a cloud server is connected to the information processing apparatus 100. The cloud server is just an example of the external device 200. Other examples of the external device 200 include, but are not limited to, a storage medium.

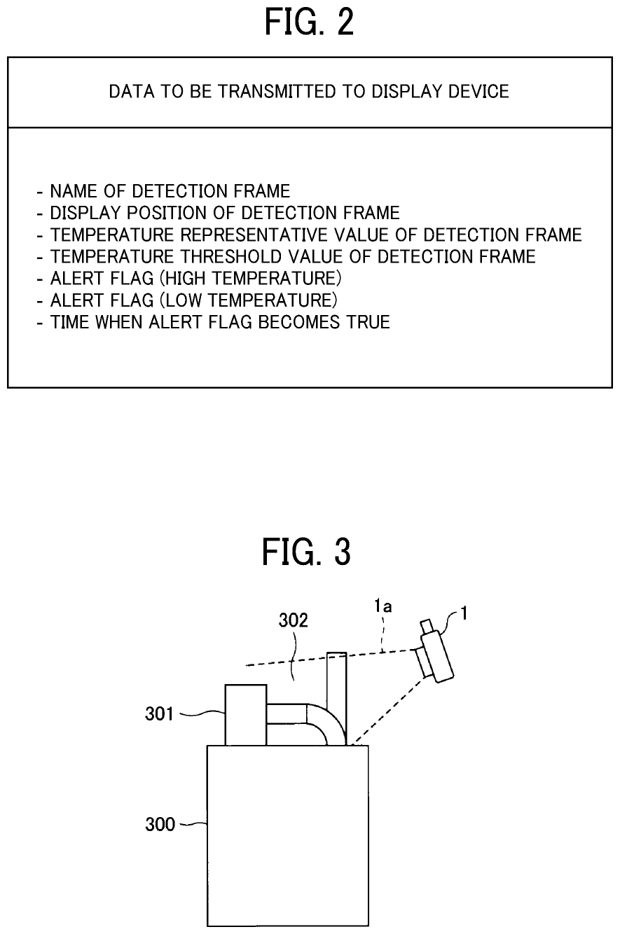

A description is now given of data to be transmitted from the processing unit 101 to the display device 102, with reference to FIG. 2.

FIG. 2 is a diagram illustrating an example of data to be transmitted to the display device 102, according to the present embodiment. The processing unit 101 according to the present embodiment transmits, as a processing result, information such as information indicating a name of a detection frame, information indicating a display position of the detection frame on the display device 102, a temperature representative value of the detection frame, a temperature threshold value of the detection frame, an alert flag (high temperature), an alert flag (low temperature), and a time when the alert flag is turned on, to the display device 102. A detailed description is given below of the processing unit 101.

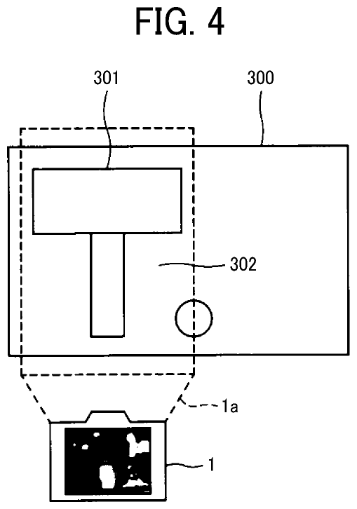

A description is now given of a monitoring target 301, which is a target to be monitored by the information processing apparatus 100, with reference to FIG. 3 and FIG. 4. FIG. 3 is a view of a device 300, which includes the monitoring target 301, viewed from the side. FIG. 4 is a view of the device 300, which includes the monitoring target 301, viewed from the above.

The device 300 is, for example, a vulcanization furnace. In the embodiments, the monitoring target 301 to be monitored by the information processing apparatus 100 is a heat generating portion (e.g., an electric heater) of the vulcanization furnace. An area surrounded by a dashed line is a monitoring area 1a, which is an area to be monitored by the camera 1. The monitoring area 1a includes the monitoring target 301 and a surrounding area 302 of the monitoring target 301. The size of the monitoring area 1a is equal to, for example, an angle of view of each of a thermographic camera and an RGB camera that the camera 1 includes. A detailed description is given below of the thermographic camera and the RGB camera.

The surrounding area 302 is, for example, an entire area around the heat generating portion. In another example, the surrounding area 302 is a part of the entire area around the heat generating portion. The part of the entire area around the heat generating portion is, for example, an area on the front side of the heat generating portion (a side where the camera 1 is provided), or an area on the back side of the heat generating portion (a side opposite to the side where the camera 1 is provided). In another example, the part of the entire area around the heat generating portion is an area other than the above-described areas, such as the upper side of the heat generating portion.

The vulcanization furnace is just an example of the device 300. Other examples of the device 300 include, but are not limited to, a lead battery, and a switchboard. In a case where the device 300 is a lead battery, for example, the monitoring target 301 is a main unit of the lead battery, and equipment existing the surrounding area 302 is, for example, a wiring connected to a positive electrode terminal or a negative electrode terminal of the lead battery. In a case where the device 300 is a switchboard, for example, the monitoring target 301 is a main unit of the switchboard, and equipment existing in the surrounding area 302 is, for example, a cable connected to the switchboard.

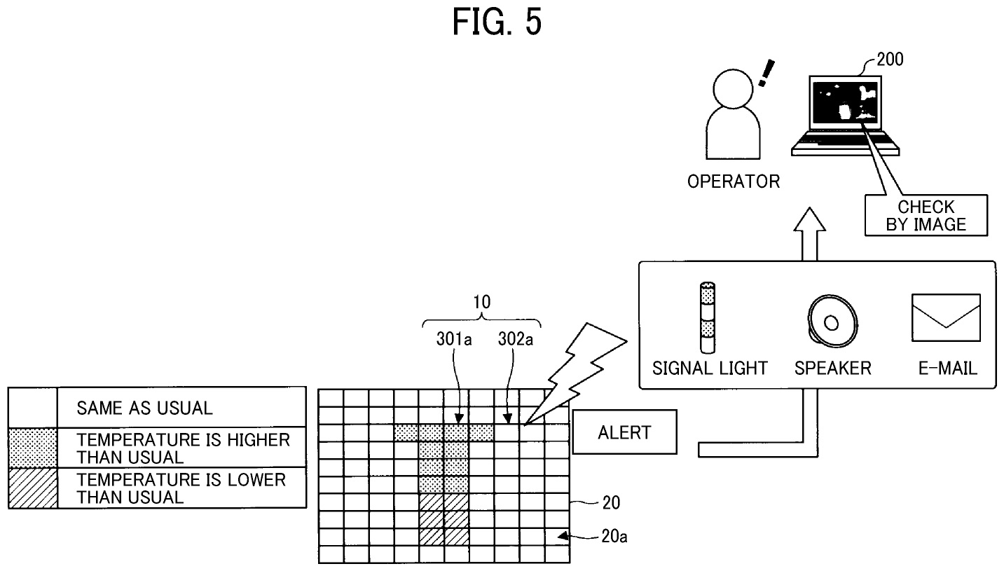

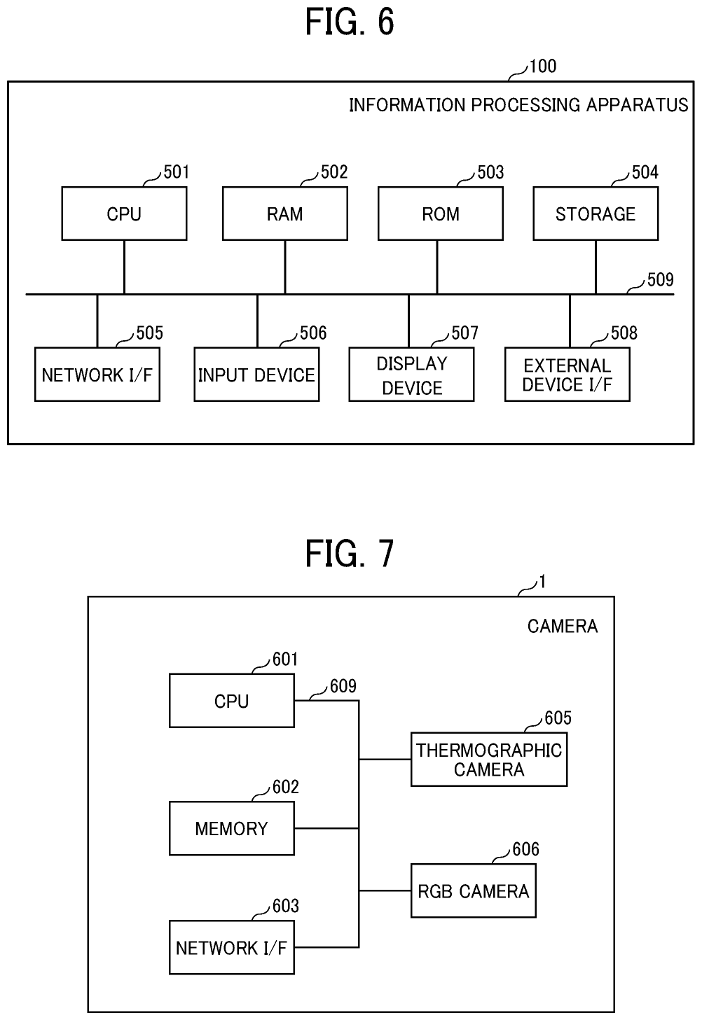

A description is given now of an overview of a monitoring operation performed by the information processing apparatus 100, with reference to FIG. 5. Further, a configuration of the information processing apparatus 100 and operation performed by the information processing apparatus are described in detail with reference to FIG. 6, etc.

FIG. 5 is a diagram for describing an overview of a monitoring operation performed by the information processing apparatus 100, according to the present embodiment. First, the information processing apparatus 100 generates a color image 10 of the monitoring area 1a based on image data obtained by imaging the monitoring area 1a, and controls the display device 102 to display the generated color image 10. The color image 10 includes, for example, a color image 301a of the monitoring target 301, and a color image 302a of the surrounding area 302. Next, the information processing apparatus 100 generates a detection frame 20 for detecting a temperature of the monitoring area 1a based on the image data obtained by imaging the monitoring area 1a, and controls the display device 102 to display the generated detection frame 20 as being superimposed on the color image 10.

The detection frame 20 is displayed in a manner that the detection frame is superimposed at least a part of each of the color image 301a and the color image 302a. More preferably, the detection frame 20 is displayed in a manner that the detection frame is superimposed on the entirety of each of the color image 301a and the color image 302a.

A rectangular shape is just an example of the shape of the detection frame 20. The detection frame 20 can have any other suitable shape such as an elliptical shape, provided that the detection frame is displayed as being superimposed on at least a part of each of the color image 301a and the color image 302a. Further, plural cells (plural regions) 20a constituting the detection frame 20 can also have a shape other than a rectangular shape. Furthermore, although the figure illustrates an example in which the plural cells 20a are regularly arranged vertically and horizontally, in another example, the plural cells are arranged irregularly.

The information processing apparatus 100 compares the temperatures of the color image 301a and the color image 302a with a predetermined threshold value (a setting value used in determining an abnormal temperature) in each of the plural cells 20a constituting the detection frame 20. According to the comparison result, when the temperature exceeds the threshold value, the information processing apparatus 100 performs alert processing. The alert processing is, for example, transmitting a notification to the display device 102, the external device 200, etc. by email. In another example, the alert processing is changing a color display of a signal light that the external device 200 or the like includes from a normal state to a warning state. In still another example, the alert processing is outputting an alarm sound from a speaker that the external device 200 or the like includes. In still another example, the alert processing is a combination of at least two of the above processing.

The threshold value has a certain range from an upper limit value to a lower limit value, e.g., from 100° C. to 90° C. When the temperature exceeds the upper limit value or falls below the lower limit value, the alert processing is performed. A detailed description is given below of an example of the alert processing.

FIG. 6 is a block diagram illustrating an example of a hardware configuration of the information processing apparatus 100. The information processing apparatus 100 includes a central processing unit (CPU) 501, a random access memory (RAM) 502, a read only memory (ROM) 503, a storage 504, a network interface (I/F) 505, an input device 506, a display device 507, an external device I/F 508 and a bus 509 through which data, control signals and the like are transmitted.

The CPU 501 is a processor that reads programs and data stored in, for example, the ROM 503 and the storage 504 to the RAM 502 and executes processing, to implement functions of the information processing apparatus 100. The RAM 502 is a volatile memory used as a work area for the CPU 501. The ROM 503 is a nonvolatile memory. The storage 504 is a storage device such as a hard disk drive (HDD) and a solid state drive (SSD). The storage 504 stores, for example, an operating system (OS), application programs, and various types of data.

The network I/F 505 is a communication interface that connects the information processing apparatus 100 to the network 104. The input device 506 is an input device such as a mouse or a keyboard, and is used to input various operations to the information processing apparatus 100. The display device 507 displays, for example, results of processing performed by the information processing apparatus 100. The external device I/F 508 is an interface that connects the information processing apparatus 100 to the external device 200. Functions of the information processing apparatus 100 are implemented by the CPU 501 executing a predetermined program, for example.

FIG. 7 is a diagram illustrating an example of a hardware configuration of the camera 1. The camera 1 includes a CPU 601, a memory 602, a network I/F 603, a thermographic camera 605, an RGB (Red/Green/Blue) camera 606, and a bus 609 through which data, control signals and the like are transmitted.

The CPU 601 is a processor that executes a predetermined program stored in the memory 602 to implement functions of the camera 1. The memory 602 is a storage device such as a RAM, a ROM, or a flash ROM. The network I/F 603 is a communication interface that connects the camera 1 to the network 104.

The thermographic camera 605 is an imaging device (imaging means) configured to take an image of heat emitted from the monitoring target 301 as infrared rays. The thermographic camera 605 takes an image of an inside of the monitoring area 1a as illustrated in FIG. 3 and FIG. 4, for example, and converts to a temperature of an object or space within the monitoring area 1a, to generate temperature imaging data and output the generated temperature imaging data. The temperature imaging data is constituted as a plurality of pixels of M×N (e.g., vertical 60×horizontal 80). The plurality of pixels includes a pixel group corresponding to the monitoring target 301 and another pixel group corresponding to the surrounding area 302 of the monitoring target 301 in the monitoring area 1a.

The RGB camera 606, for example, takes an image of the inside of the monitoring area 1a, to generate RGB imaging data in which colors of an object or space in the imaged monitoring area 1a are represented by the intensity values of RGB (three colors) and output the generated RGB data. In substantially the same manner as the temperature imaging data, the RGB imaging data is constituted as a plurality of M×N pixels.

Hereinafter, the temperature imaging data and the RGB imaging data may be referred to as “imaging data”, unless they need to be distinguished from each other.

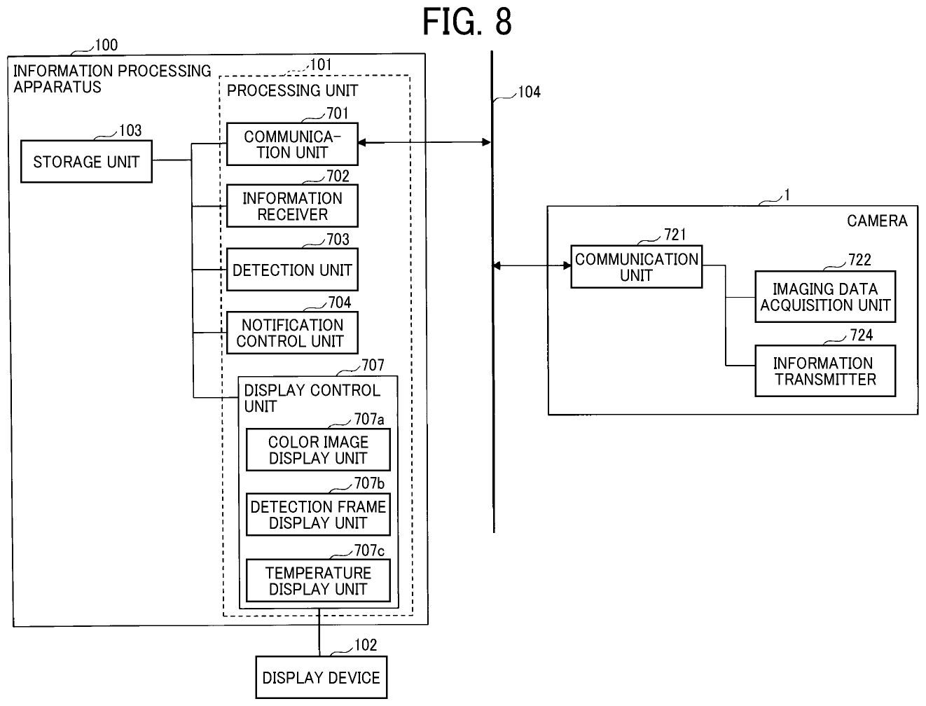

FIG. 8 is a diagram illustrating an example of functional configurations of the information processing apparatus 100 and the camera 1. The information processing apparatus 100 includes a communication unit 701, an information receiver 702, a detection unit 703, a notification control unit 704, a display control unit 707, and a storage unit 103. The information processing apparatus 100 executes a predetermined program to implement the functions of the communication unit 701, the information receiver 702, the detection unit 703, the notification control unit 704, and the display control unit 707.

The communication unit 701 connects the information processing apparatus 100 to the network 104, to allow the information processing apparatus to communicate with the camera 1 and the external device 200. The information receiver 702 receives imaging data from the camera 1 and stores the received imaging data in the storage unit 103.

The detection unit 703 detects a temperature change in each of the regions (the cells 20a) in the detection frame 20 based on the imaging data from the camera 1. The notification control unit 704 compares the temperatures of the color image 301a and the color image 302a with the predetermined threshold value (the setting value used in determining an abnormal temperature) in the plural cells 20a constituting the detection frame 20, to perform the alert processing, i.e., notification processing, when the temperature exceeds the threshold value. In the following description, performing the notification processing may be referred to as “(to) notify that the temperature exceeds the threshold value”.

The display control unit 707 controls, for example, display by the display device 102 or display by the external device 200. The display control unit 707 includes a color image display unit 707a, a detection frame display unit 707b, and a temperature display unit 707c.

The color image display unit 707a generates the color image 10 of the monitoring area 1a based on the imaging data output from an imaging data acquisition unit 722, described below, that takes an image of the monitoring area 1a including the monitoring target 301 and the surrounding area of the monitoring target, and controls the display device 102 to display the generated color image. The detection frame display unit 707b generates the detection frame 20 constituted as the plural cells 20a for detecting the temperature of the monitoring area 1a based on the imaging data, and controls the display device 102 to display the generated detection frame 20 as being superimposed on the color image 10. The temperature display unit 707c displays at least a temperature in each of the plural cells 20a constituting the detection frame 20.

In other words, the temperature display unit 707c displays at least temperature information indicating the temperature in each of a plurality of regions constituting the detection frame.

Examples of the temperature display include, but are not limited to, a display of a temperature value such as 25° C. or 40° C. and a color corresponding to the temperature value, such as 25° C. is displayed in blue and 40° C. is displayed in red.

The camera 1 includes a communication unit 721, the imaging data acquisition unit 722, and an information transmitter 724.

The communication unit 721 connects the camera 1 to the network 104, to allow the camera to communicate with the information processing apparatus 100. The imaging data acquisition unit 722 acquires imaging data using the thermographic camera 605 and the RGB camera 606 described above. The information transmitter 724 transmits the imaging data acquired by the imaging data acquisition unit 722 to the information processing apparatus 100.

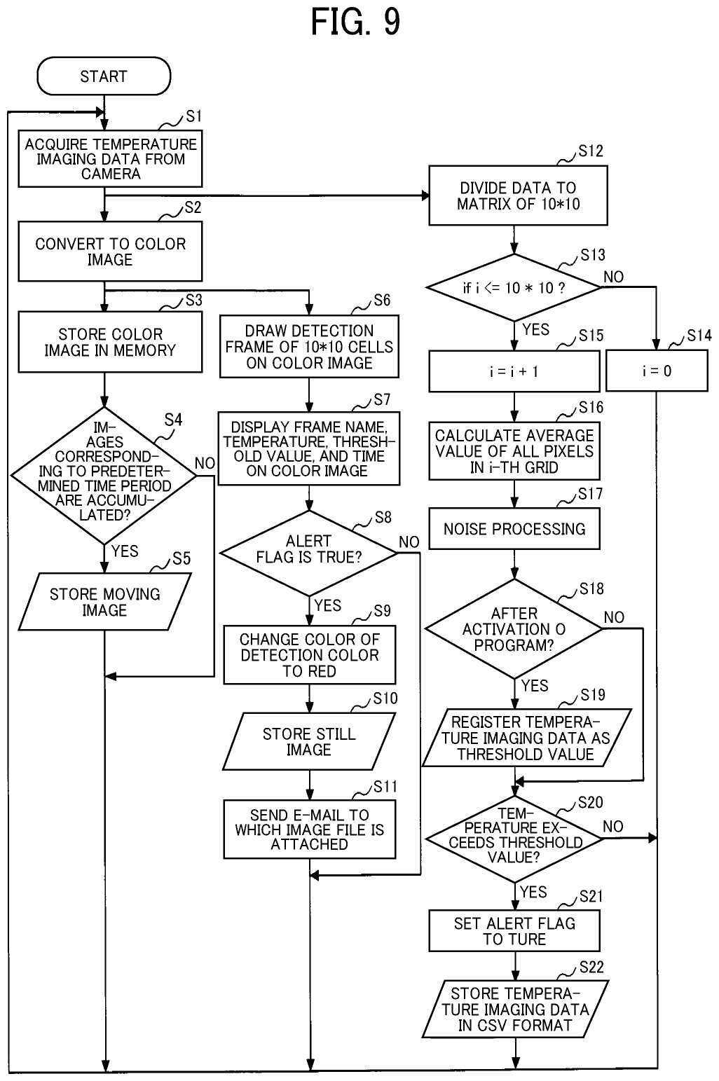

A description is now given of operation performed by the information processing apparatus 100, with reference to FIG. 9 to FIG. 17.

FIG. 9 is a flowchart illustrating an example of operation performed by the information processing apparatus 100.

In step S1, the program installed in the information processing apparatus 100 is activated, and thereby the processing unit 101 accesses the camera 1 to acquire imaging data.

In step S2, the processing unit 101 converts the acquired imaging data into an RGB color image based on a preset color map. The converted color image is stored in the memory of the information processing apparatus 100 (step S3).

When the imaging data corresponding to a predetermined time period (e.g., a few minutes) is accumulated (step S4: YES), the processing unit 101 stores a moving image file in a storage folder (step S5).

Thus, when any abnormality occurs in the monitoring target 301, an operator checks the monitoring target 301 and a situation surrounding the monitoring target as viewing the moving image, and identify the cause of the abnormality without difficulty.

In step S6, the processing unit 101 displays the color image on a graphical user interface (GUI) screen and further draws the detection frame on the color image. Examples of the GUI screen include, but are not limited to, an operation screen displayed on the display device 102 or a monitor of the external device 200.

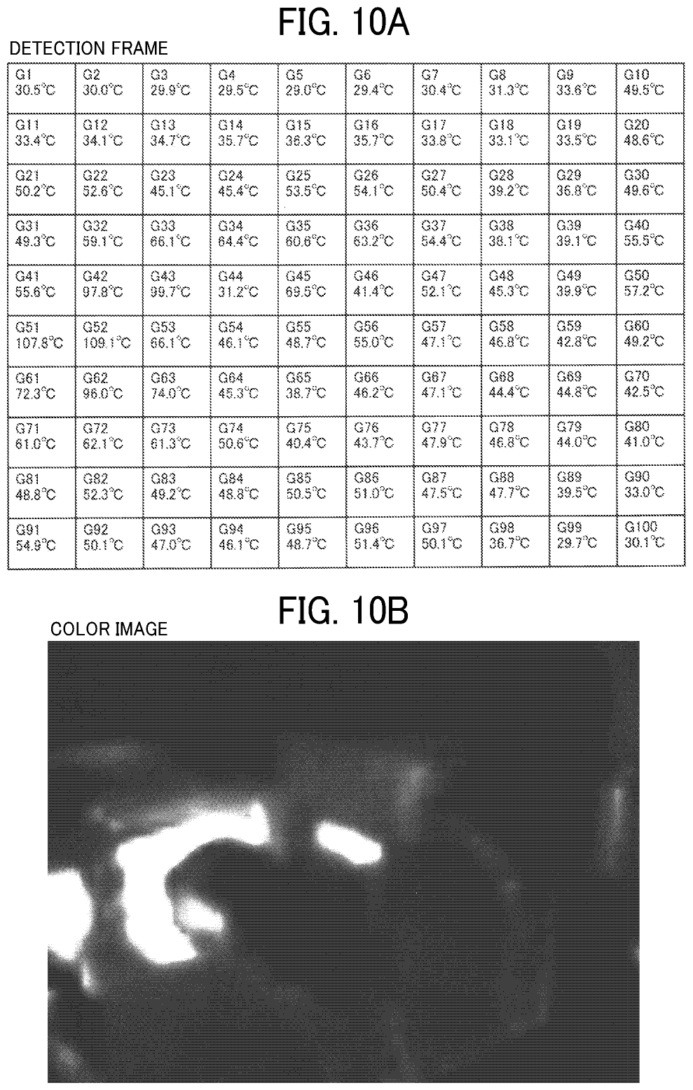

Examples of the color image and the detection frame are illustrated in FIG. 10A and FIG. 10B, respectively. FIG. 10A and FIG. 10B are diagrams illustrating examples of the detection frame and the color image. FIG. 10A illustrates an example of the detection frame, and FIG. 10B illustrates an example of the color image.

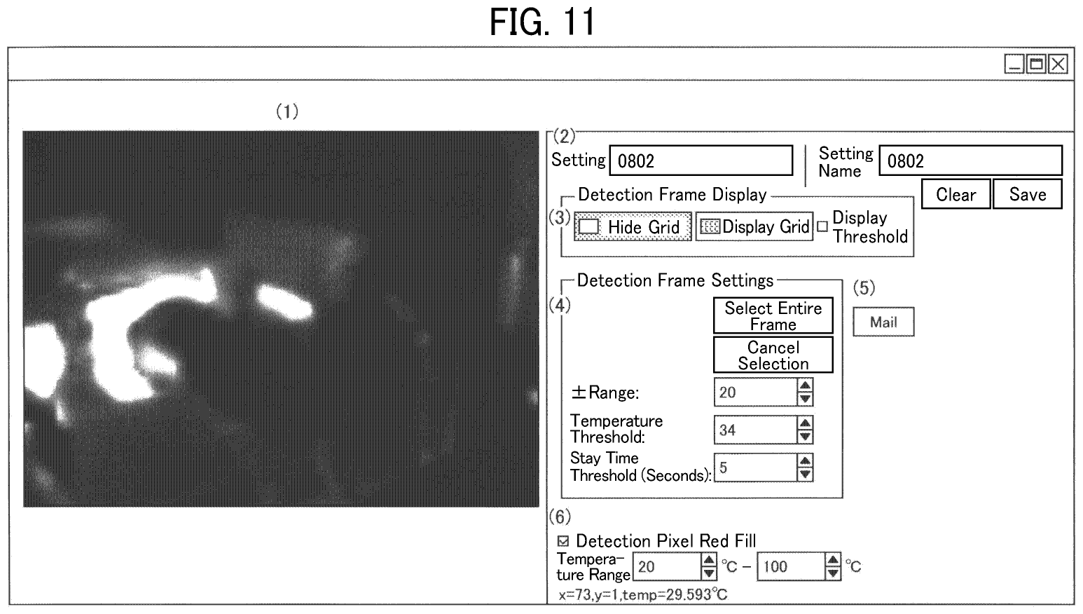

FIG. 11 is a diagram illustrating an example of the color image displayed on the GUI screen FIG. 11 illustrates a state in which the detection frame is not yet superimposed on the color image. In the example, the color image is displayed in an area indicated by (1) in FIG. 11 (a left half area on the GUI screen).

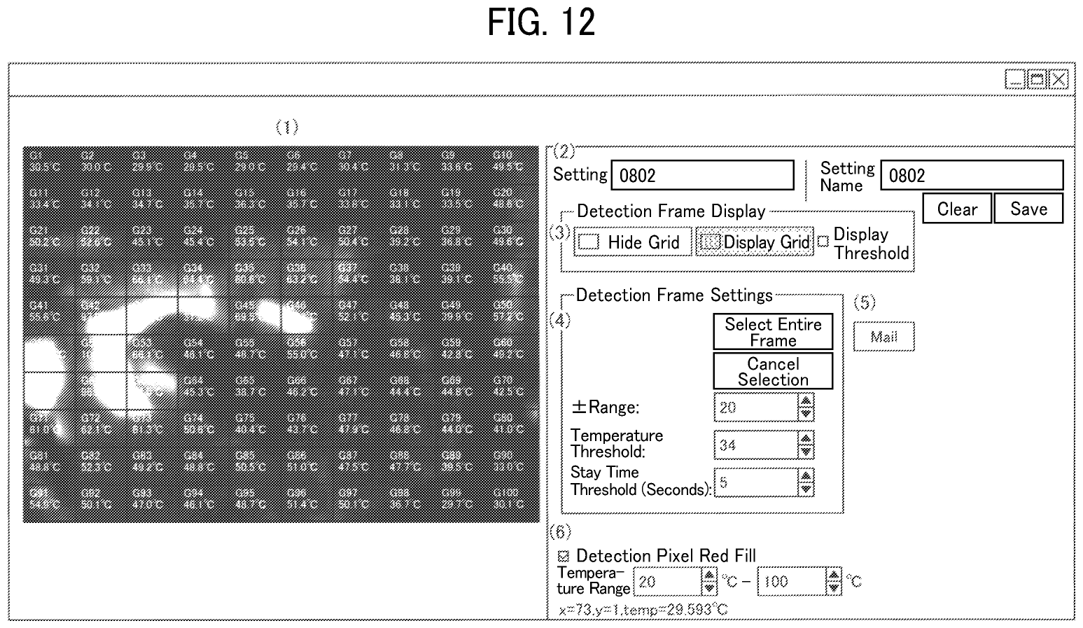

FIG. 12 is a diagram illustrating a state in which the detection frame is superimposed on the color image on the GUI screen. The detection frame is constituted as, for example, 100 grids (vertical 10 cells×horizontal 10 cells). This detection frame is displayed as being superimposed on the color image. The detection frame is displayed in a color (e.g., blue) distinguishable from the color image.

In a right half area of the GUI screen, setting buttons indicted by (2) to (6) are displayed. For example, in a “Setting” field indicated by (2), a desired name of an image file when the image file is to be saved is set. Either one of buttons in a “Detection Frame Display” field indicated by (3) is selected to switch whether to display only an image represented by the imaging data, to display only the detection frame, or to display both of the image and the detection frame. In a “Detection Frame Settings” field indicated by (4), the temperature threshold value is set. In an email setting field indicated by (5), an email address of a notification destination is set. A camera image setting field indicated by (6) is provided to change a display mode of the color image to a desired mode. For example, in the camera setting filed, the temperature range is set to a desired range such as from 20° C. to 300° C. Further, for example, in the camera setting field, a setting is configured of filling one or more cells in the detection frame with red when any abnormality is detected in the corresponding cell(s) and making no change to other cells. The values set in the setting buttons (1) to (6) are examples of a parameter.

Referring again to FIG. 9, in step S7, the processing unit 101 displays, for example, a grid name, a temperature, a threshold value, and a time in each of the cells (grids) in the detection frame as illustrated in FIG. 12. The frame name is a name of each frame such as Gl. G is an abbreviation for grid. When the grid name, temperature, threshold value, and time change, the processing unit 101 sequentially updates the information in the detection frame.

In step S8, when the processing unit 101 determines, for example in a process of step S20 (described below), that the alert flag becomes true (=1) because the temperature corresponding to one of the cells exceeds the threshold value, the processing unit 101 changes the color of corresponding cell of the detection frame from blue to red, for example (step S9). In other words, among the plural cells, a portion where the temperature reaches an abnormal temperature is highlighted.

Further, the processing unit 101 stores a still image including the GUI screen and the color image at a time when the color of the cell changes in a storage folder (step S10), and the notification control unit 704 transmits an alert email to which the still image is attached to a desired email address (step S11). The storage folder is generated in the storage unit 103, for example. Therefore, the storage unit 103 is an example of a storage unit configured to store the color image.

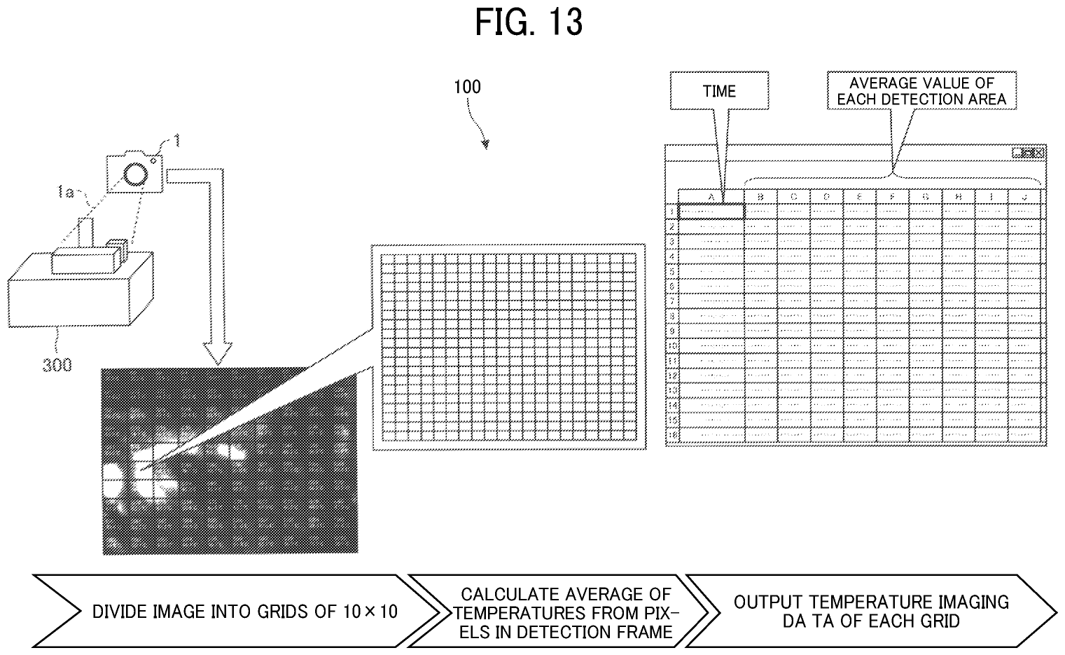

Next, in steps S12 to S17, the processing unit 101 divides the temperature imaging data (e.g., data constituted as pixels of horizontal 80×vertical 60) into a submatrix of horizontal 10×vertical 10, that is, divides the color image to a submatrix (see FIG. 13). Thus, a matrix of an N/10×M/10 for each of submatrices is generated. N and M are integers of 1 or more. The processing unit 101 processes the submatrix data of the divided temperature imaging data in order, to calculate an average temperature value from all temperature pixels in the submatrix (see FIG. 13), and performs noise processing. The noise processing is performed to eliminate sudden abnormalities.

When the program is already activated (step S18: YES), the processing unit 101 registers the temperature imaging data as a threshold value (step S19).

Further, the processing unit 101 compares the calculated average temperature value with the threshold value, and when the comparison result indicates that the average temperature value exceeds the threshold value (step S20: YES), the processing unit 101 turns on the alert flag (step S21).

Finally, the processing unit 101 stores the calculated average temperature value in a CSV format (see FIG. 13) in the storage folder (step S22).

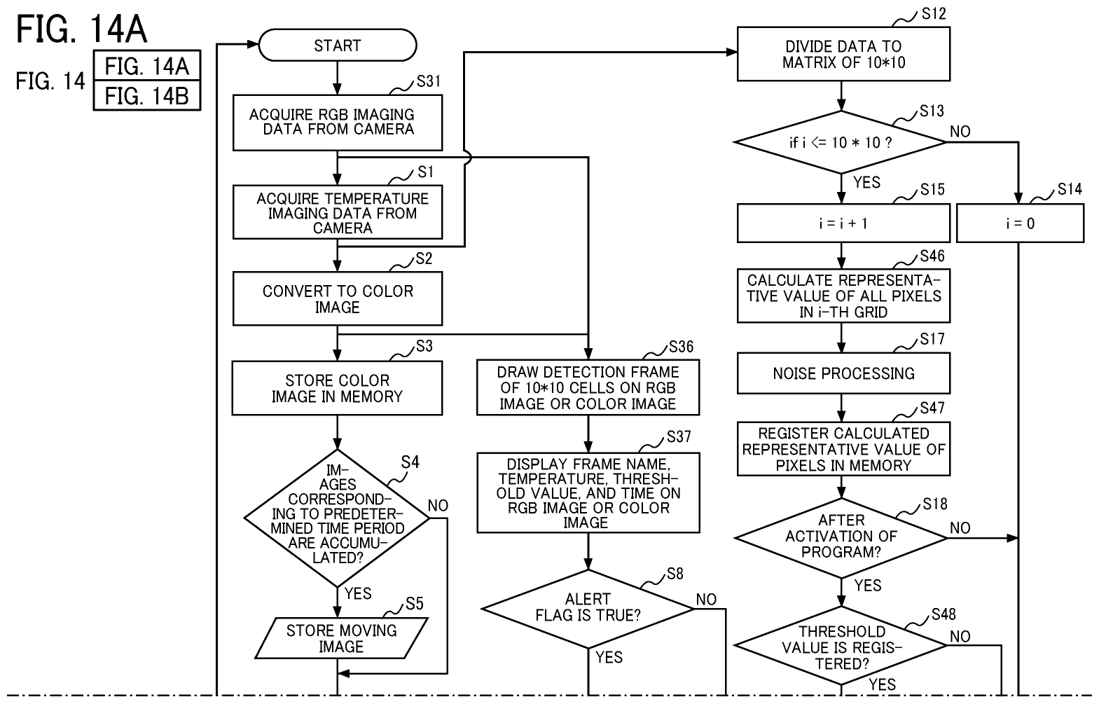

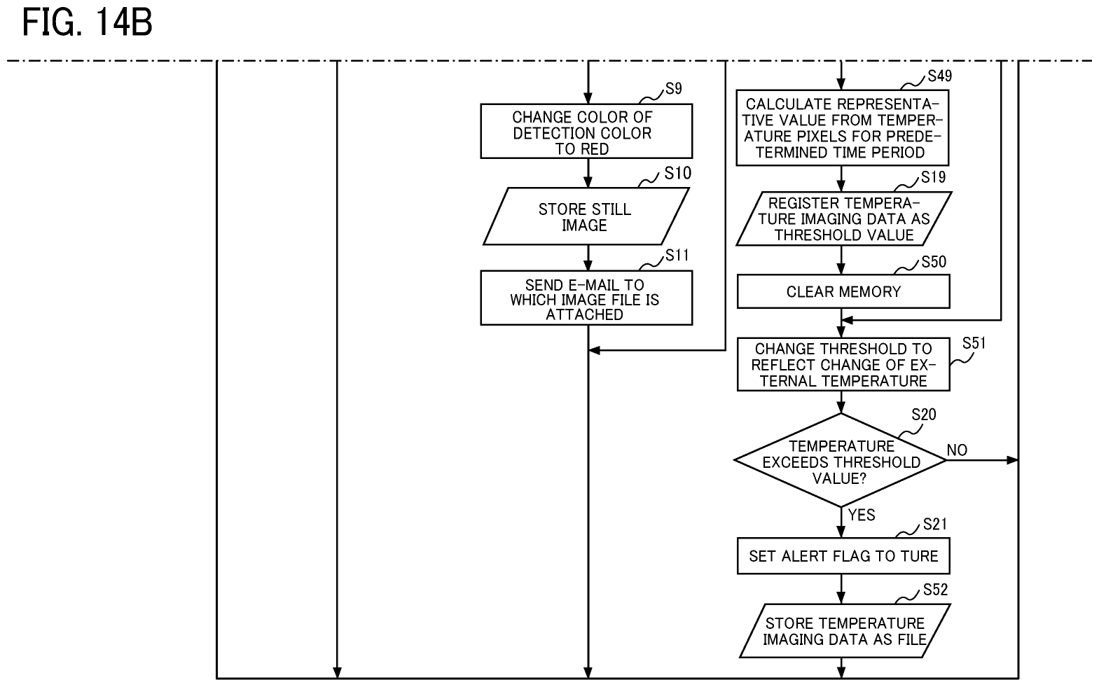

Although the description given above is of an example of the operation in which the detection frame is drawn on the color image, the embodiment is not limited thereto. In another example, the detection frame is drawn on the RGB image. Hereinafter, a description is given of an example of operation in which the detection frame is drawn on the RGB image, with reference to FIGS. 14A and 14B to FIG. 16. In the following, the description of processes that are the same or substantially the same as the processes described with reference to FIG. 9 is omitted, and processes different from the processes described with reference to FIG. 9 are described.

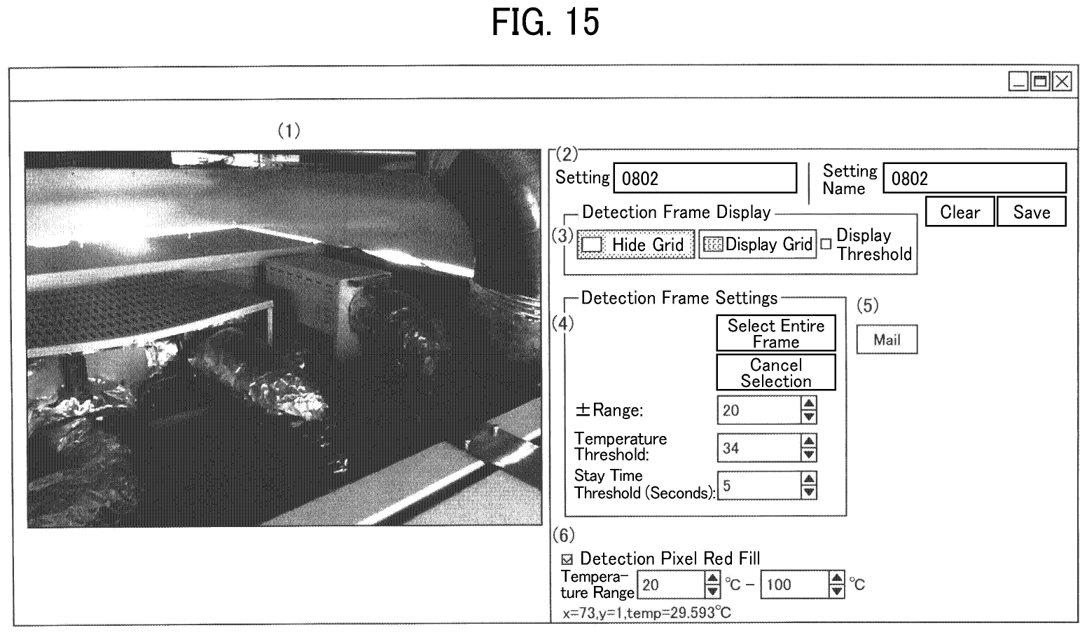

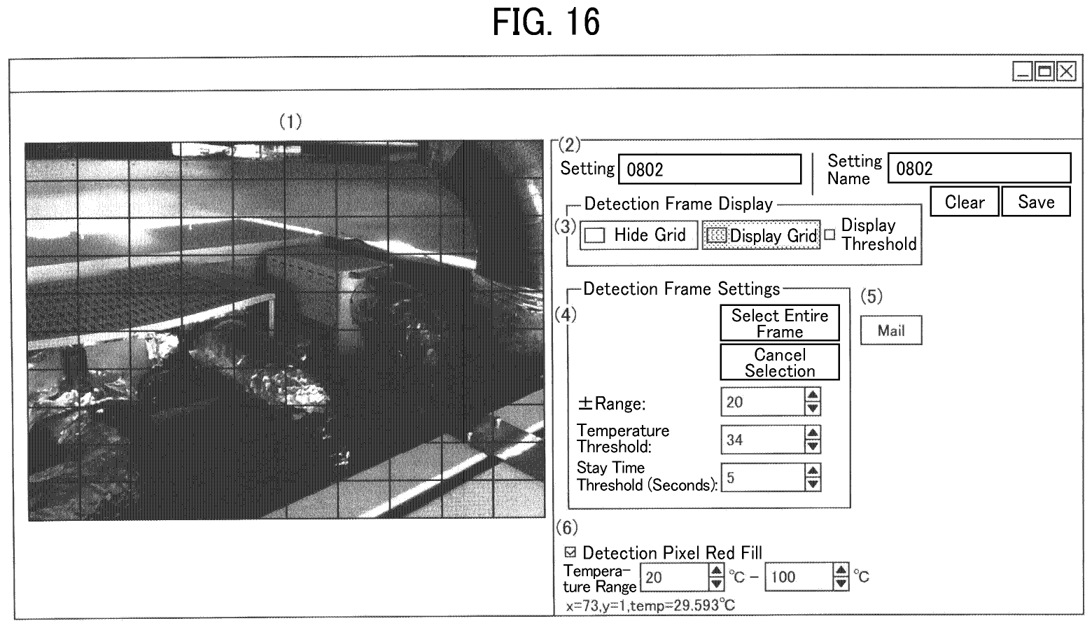

FIGS. 14A and 14B are flowcharts illustrating an example of operation, according to a variation. FIG. 15 is a diagram illustrating an example of an RGB image displayed on the GUI screen. FIG. 16 is a diagram illustrating a state in which the detection frame is superimposed on the RGB image on the GUI screen.

For example, before step S1, when the processing unit 101 acquires the RGB imaging data from the camera 1, the processing unit 101 converts the RGB imaging data into an RGB image (step S31). The processing unit 101 displays the RGB image on the GUI screen as illustrated in FIG. 15, and further draws the detection frame on the RGB image as illustrated in FIG. 16 (step S36).

Note that in one example, the process of converting the RGB imaging data into the RGB image is performed in step S2. In another example, such process is performed after a conversion process into color pixels (e.g., step S36). Further, in one example, the processing unit 101 stores the RGB image together with the color image in the memory, and when the RGB images correspond to a predetermined time period are accumulated, stores a moving image file in a desired storage folder. This enables an operator to identify a cause of the abnormality by checking a clear moving image as illustrated in FIG. 15 without difficulty.

In step S37, the processing unit 101 displays, for example, a grid name, a temperature, a threshold value, and a time in each of the cells (grids) in the detection frame.

Next, in steps S12 to S17, the processing unit 101 divides the temperature imaging data into a submatrix of horizontal 10×vertical 10. Thus, a matrix of an M/10×N/10 for each of submatrices is generated. M and N are integers of 1 or more. The processing unit 101 processes the submatrix data of the divided temperature imaging data in order, to calculate a representative value from all temperature pixels in the submatrix, and performs noise processing.

The processing unit 101 stores the calculated representative value of pixels in the memory until a predetermined time period elapses after the program is activated. Thereby, the processing unit 101 calculates the representative value from the temperature imaging data corresponding to a predetermined time period and registers the calculated representative value as a threshold value (steps S18 to S19).

Thereafter, the processing unit 101 clears data in the memory (step S50), and when an external temperature change occurs due to air temperature or seasonal fluctuation, updates the threshold value to reflect such change to set the updated threshold value as a new threshold value (step S51).

The processing unit 101 compares the calculated average temperature value with the threshold value, and when the comparison result indicates that the average temperature value is out of the threshold value, the processing unit 101 turns on the alert flag (step S21). The processing unit 101 stores the average temperature value that is calculated most recently as a file in the storage folder (step S52).

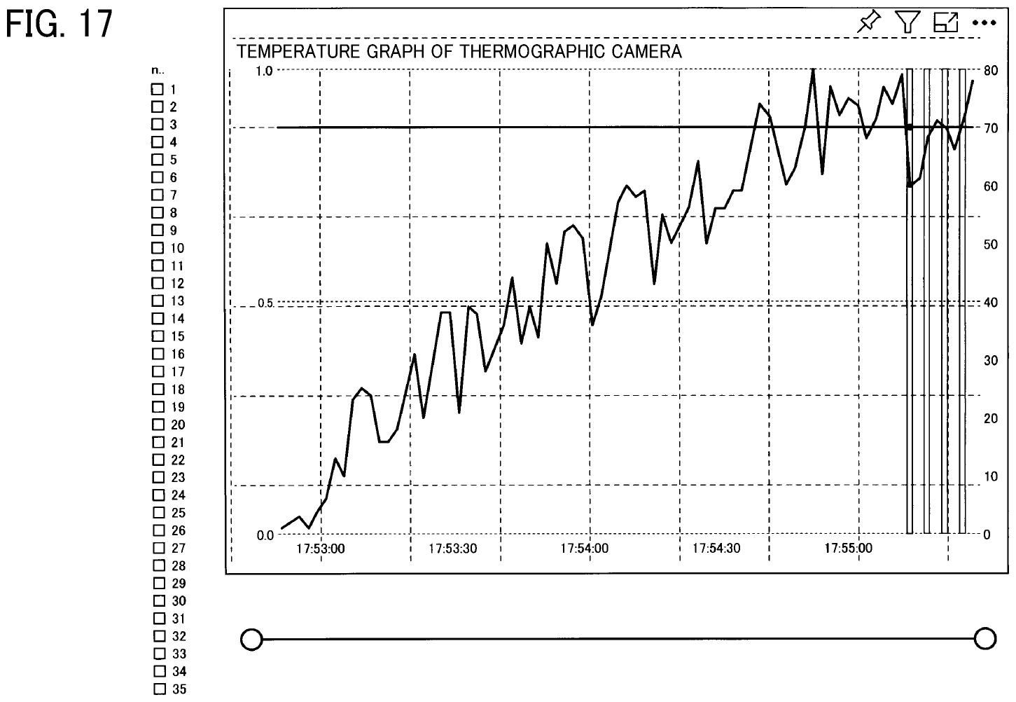

FIG. 17 is a diagram illustrating an example of display of a graph indicating a tendency of temperature change. The graph illustrated in FIG. 17 is displayed, for example, in response to selection of a desired one of the plural cells (grids) illustrated in FIG. 12, and represents a transition of the temperature in each cell in a chronological order. The graph plots temperatures measured at regular intervals such as every several seconds or every several minutes. By using this graph, the temperature change tendency (temperature change trend) in each grid is checked.

Further, in one example, when the operator clicks a bar displayed corresponding to a time when the temperature exceeds the threshold value, the image file (at least one of the moving image file and the still image file) imaged at the corresponding time is reproduced, or the alert history is displayed. In another example, when desired two or more cells are collectively selected in the plural cells (grids) illustrated in FIG. 12, a graph indicating an average value of the temperatures of the selected cells is displayed.

As described heretofore, the information processing apparatus 100 according to the present embodiment includes a color image display unit configured to generate a color image of a monitoring area including a monitoring target and a surrounding area of the monitoring target, based on imaging data output from an imaging unit configured to take an image of the monitoring area, and display the generated color image on a display unit. The information processing apparatus 100 according to the present embodiment further includes a detection frame display unit configured to generate a detection frame constituted as plural cells for detecting a temperature of the monitoring area based on the imaging data, and display the generated detection frame as being superimposed on the color image on the display unit. The information processing apparatus 100 according to the present embodiment further includes a temperature display unit to display a temperature in each of the plural cells. Examples of the display unit include, but are not limited to, a the display device 102 and a monitor of the external device 200.

With this configuration, based the imaging data obtained by imaging the monitoring area 1a including the monitoring target 301 and the surrounding area 302, the detection frame 20 is displayed as being superimposed on the color image 10 of the monitoring area 1a on the display device, and at least the temperature in the monitoring area 1a is displayed in the cells of the detection frame 20. Thus, even in a case where the monitoring area 1a as illustrated in FIG. 3 and FIG. 4 is set, when sparks or the like produced from the monitoring target 301 leaps to equipment existing around the monitoring target 301, a temperature of the equipment is monitored. Further, even when a heat source (e.g., a person or a mobile device) approaches the monitoring target 301, in a case where there is no abnormality in the monitoring target 301, a temperature abnormality of the monitoring target 301 caused by the heat source is not erroneously detected. Therefore, the temperature of the monitoring target 301 is appropriately detected while suppressing erroneous detection of the temperature abnormality of the monitoring target 301 caused by a heat source other than the monitoring target 301.

Furthermore, according to the information processing apparatus 100, a detection area (detection frame) provided in the entire color image makes the most merits of a feature of a thermal image sensor (camera 1) capable of capturing a temperature in a wide range.

Further, recording a moving image makes the most merits of a feature of visualizing the temperature of the thermal image sensor. In the background, since only an image when a temperature exceeds a threshold temperature is saved, it is not possible to check a situation corresponding to a certain time period before and after a fire occurrence of the monitoring target 301. The information processing apparatus 100 according to the present embodiment enables to check a state of the monitoring target 301 in detail, thereby for example, enabling to determine whether the cause of the fire of the monitoring target 301 is due to an abnormality of equipment existing in the vicinity of the monitoring target or an abnormality of the monitoring target 301 itself. Furthermore, compared with a graph of a temperature imaging data, the moving image makes it easier to recognize the tendency and cause of abnormal temperature.

Further, according to the present embodiment, a change in temperature at any position is supported, provided that the change occurs within the angle of view of the camera 1. Therefore, during a time period when the system is in operation, the temperature imaging data and the visualized image of the thermal image sensor is saved for each area, thereby the abnormal tendency is analyzed based on the temperature imaging data before and after the notification process by the information processing apparatus 100.

The way how to generate the detection frame is not particularly limited. For example, the detection frame is generated by matrix data. Alternatively, for example, the detection frame is expressed by a wire frame.

Further, in one example, the information processing apparatus 100 automatically restarts when a certain time period has elapsed after the generation of the color image is stopped. This enables continuous monitoring while maintaining the real-time feature of image generation, even when the generation of the color image is temporarily stopped.

Furthermore, the thermographic camera 605 and the RGB camera 606 sometimes different angles of view from each other. Therefore, preferably, in superimposing the detection frame on the color image or the RGB image, the information processing apparatus 100 corrects the angles of view of the thermographic camera 605 and the RGB camera 606, and superimposes the detection frame on the color image or the RGB image whose angles of view are corrected.

The information processing system according to the present embodiment includes the information processing apparatus 100 and the camera 1 as the imaging unit.

An information processing method performed by an information processing apparatus according to the present embodiment includes a receiving step of receiving imaging data output from an imaging device. The information processing method further includes a processing step of generating a color image based on the received imaging data and controlling a display device to display the generated color image. The processing step includes generating a detection frame constituted as plural regions based on the imaging data, controlling the display device to display the generated detection frame as being superimposed on the color image, and displaying a temperature for each of the plural regions.

A program according to the present embodiment causes a computer to perform a receiving step of receiving imaging data output from an imaging device. The program further causes the computer to perform a processing step of generating a color image based on the received imaging data and controlling a display device to display the generated color image. The processing step includes generating a detection frame constituted as plural regions based on the imaging data, controlling the display device to display the generated detection frame as being superimposed on the color image, and displaying a temperature for each of the plural regions.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a TCP/IP signal carrying computer code over an IP network, such as the Internet. The carrier medium also includes a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application No. 2020-001631, filed on Jan. 8, 2020, in the Japan Patent Office, the entire disclosure of which is incorporated herein by reference.

### REFERENCE SIGNS LIST

1 Camera
1a Monitoring area
10 Color image
20 Detection Frame
100 Information processing apparatus
101 Processing unit
102 Display device
300 Device
301 Monitoring target
301a Color image
302 Surrounding area
302a Color image
605 Thermographic camera
703 Detection unit
704 Notification control unit
707 Display control unit

1. An information processing apparatus, comprising:
an information receiver configured to receive imaging data; and
processing circuitry configured to generate a color image based on the received imaging data and control a display to display the generated color image,
wherein the processing circuitry generates a detection frame including plural regions based on the imaging data, controls the display to display the generated detection frame as being superimposed on the color image, and displays a temperature for each of the plural regions.

2. The information processing apparatus of claim 1, further comprising a memory to store a plurality of the color images, wherein:
the processing circuitry controls the display to display a moving image based on the plurality of the color images stored in the memory.

3. The information processing apparatus of claim 1, wherein:
the processing circuitry controls the display to display a graphical user interface (GUI) that receives an instruction for changing a parameter.

4. The information processing apparatus of claim 1, wherein:
the processing circuitry displays a threshold value based on which the temperature is checked in each of the plural regions.

5. The information processing apparatus of claim 4, wherein:
the threshold value is a value having a certain range from an upper limit value to a lower limit value, and
the information processing apparatus further includes notification control circuitry configured to, in any one of cases where the temperature exceeds the upper limit value and where the temperature is less than the lower limit value, notify that the temperature exceeds the threshold value.

6. The information processing apparatus of claim 5, wherein:
the notification control circuitry transmits an email containing the color image, to notify that the temperature exceeds the threshold value.

7. The information processing apparatus of claim 5, wherein:
the notification control circuitry notifies an external device that the temperature exceeds the threshold value.

8. The information processing apparatus of claim 1, wherein:
among the plural regions, a portion where the temperature reaches an abnormal temperature is highlighted.

9. The information processing apparatus of claim 1, wherein:
the information processing apparatus automatically restarts when a certain time period elapses after generation of the color image is stopped.

10. An information processing system comprising:
the information processing apparatus according to claim 1;
an imaging device which outputs the imaging data; and
the display.

11. An information processing method, comprising:
receiving imaging data;
generating a color image based on the received imaging data;
controlling a display to display the generated color image;
generating a detection frame including plural regions based on the imaging data;
controlling the display to display the generated detection frame as being superimposed on the color image; and
displaying a temperature for each of the plural regions.

12. A non-transitory computer readable storage medium storing a program for causing a computer to perform a method comprising:
receiving imaging data output;
generating a color image based on the received imaging data;
controlling a display to display the generated color image;
generating a detection frame including plural regions based on the imaging data;
controlling the display to display the generated detection frame as being superimposed on the color image; and
displaying a temperature for each of the plural regions.
